(19) United States
(12) Patent Application Publication
(10) Pub. No.: US 2010/0193443 A1
(43) Pub. Date: Aug. 5, 2010

(54) TOTAL ORGANIC CARBON (TOC) REDUCTION IN BRINE VIA CHLORINOLYSIS

(76) Inventors: Sunil K. Chaudhary, Missouri City, TX (US); Bruce Hook, Lake Jackson, TX (US); Christopher P. Christenson, Seguin, TX (US); Chauvel J. Jean, Lake Jackson, TX (US); David West, Houston, TX (US); Steve Gluck, Lake Jackson, TX (US); Celio Lume Pereira, Stade (DE); Istvan Lengyel, Lake Jackson, TX (US); Frank Koester, Bremervoerde (DE)

Correspondence Address: The Dow Chemical Company, P.O. BOX 1967, Midland, MI, 48641, US

(21) Appl. No.: 12/670,142

(22) PCT Filed: Aug. 18, 2008
(86) PCT No.: PCT/US2008/073446

§ 371 Date: Jan. 22, 2010

Related U.S. Application Data
(60) Provisional application No. 60/957,675, filed on Aug. 23, 2007.

(51) Int. Cl. C02F 9/04; C02F 1/42; C02F 1/76; C02F 101/30

(52) U.S. Cl. 210/668

(57) ABSTRACT

A plurality of stages is employed to reduce the total organic carbon (TOC) content of a brine by-product stream to produce a recyclable brine stream having a TOC content of less than about 10 ppm. In a first stage treatment, a brine by-product stream may be subjected to chlorinolysis at a temperature of less than about 125 0C to obtain a chlorinolysis product having a TOC content of less than about 100 ppm, which may be treated in a second stage with activated carbon to obtain a TOC content of less than about 10 ppm. The chlorinolysis may be a reaction with sodium hypochlorite, which may be produced in situ by treatment of the brine by-product stream with chlorine gas and sodium hydroxide. The brine by-product stream may contain a high amount of difficult to remove glycerin, such as a brine by-product stream from the production of epichlorohydrin from glycerin.

### CROSS-REFERENCE TO RELATED APPLICATIONS

The present application is related to the following applications, filed on even date herewith, with the disclosures of each the applications being incorporated by reference herein in their entireties:

Application Ser. No. ______ (Attorney Docket No. 66323), filed on even date herewith, entitled “Brine Purification”.

Application Ser. No. ______ (Attorney Docket No. 66325), filed on even date herewith, entitled “Process and Apparatus for Purification of Industrial Brine”.

Application Ser. No. ______ (Attorney Docket No. 66326), filed on even date herewith, entitled “Process, Adapted Microbes, Composition and Apparatus for Purification of Industrial Brine”.

Application Ser. No. ______ (Attorney Docket No. 66327), filed on even date herewith, entitled “Brine Purification”.

### FIELD OF THE INVENTION

The present invention relates to processes for reducing the total organic carbon content of a brine by-product stream.

### BACKGROUND OF THE INVENTION

In chemical processes, maximum utility of water with discharge being the last resort, and the ability to recycle or use by-products in other processes, particularly in nearby processes are environmentally and economically desirable. Some chemical processes produce a brine by-product stream with high total organic carbon (TOC) and high sodium chloride content. For example some chemical processes result in a TOC of up to about 20,000 ppm with a sodium chloride content of up to about 23% by weight. If the TOC can be significantly reduced in concentration, there is the possibility for recycling the brine stream as a raw material for other processes, such as a chloro-alkali process or an electrolysis process. The presence of sodium chloride may pose difficulties in the removal of organic compounds from various brine by-product streams because some removal processes may cause deleterious precipitation of the sodium chloride in separation equipment. Also, the presence of the chloride ion may result in the formation of undesirably corrosive or toxic chlorinated organic compounds during chemical treatment to destroy the organic compounds. The brine by-product stream may also contain a variety of organic compounds, some of which may be difficult to remove by traditional techniques such as extraction or carbon bed treatment.

For example, in the production of epichlorohydrin from glycerin, a by-product brine stream may have a TOC of up to about 2500 ppm, typically about 1500 ppm and a sodium chloride content of up to about 23% by weight, typically about 20% by weight. For the successful implementation of a glycerin to epichlorohydrin process and related waste reduction and economic optimization, the discharge of brine should be integrated in the site environmental strategy. The level of sodium chloride is too high for direct discharge, after TOC removal, to the environment. The concentration of NaCl is also too high for effective wastewater treatment without significant consumption of fresh water and a corresponding increase in the necessary capacity of the wastewater operation. The main TOC component of the by-product brine stream is glycerin, with the other compounds contributing to TOC of the brine including glycidol, DCH, MCH, epichlorohydrin, diglycerol, triglycerol, other oligomeric glycerols, chlorohydrins of oligomeric glycerols, acetic acid, formic acid, lactic acid, glycolic acid, and other aliphatic acids. The TOC specifications for the usage of this brine by a nearby or on-site chloro-alkali process may be only 10 ppm or less. However, the major component of the TOC is glycerin which is difficult to remove by traditional techniques such as extraction or carbon bed treatment.

U.S. Pat. No. 5,486,627 to Quaderer, Jr. et al discloses a method for producing epoxides which is continuous, inhibits formation of chlorinated byproducts, and eliminates or substantially reduces waste water discharge. The method includes: (a) forming a low chlorides aqueous hypochlorous acid solution; (b) contacting the low chlorides aqueous hypochlorous acid solution with at least one unsaturated organic compound to form an aqueous organic product comprising at least olefin chlorohydrin; (c) contacting at least the olefin chlorohydrin with an aqueous alkali metal hydroxide to form an aqueous salt solution product containing at least epoxide; and (d) isolating the epoxide from the aqueous salt solution; wherein water is recovered from the product of at least Step (b) and recycled into Step (a) for use in forming the low chlorides aqueous hypochlorous acid solution. In this process, not only is the water internally recycled after Step (b), but a concentrated brine solution is generated in both Steps (a) and (d) which is useful in other processes such as electrochemical production of chlorine and caustic. The chlorine and caustic, in turn, may then be recycled back for use in forming the low chlorides aqueous HOCl solution. According to U.S. Pat. No. 5,486,627, it is generally preferred, prior to recycling into the chlor-alkali electrochemical cell, to remove any impurities from the brine. These impurities, it is disclosed typically comprise traces of the organic solvent as well as HOCl decomposition products such as chloric acid and sodium chlorate. A method for removing these impurities may include acidification and chlorinolysis or absorption on carbon or zeolites.

Methods for removing impurities from brine before passing through a chloralkali electrochemical cell are disclosed in U.S. Pat. No. 5,532,389 to Trent et al; U.S. Pat. No. 4,126,526 to Kwon et al; U.S. Pat. No. 4,240,885 to Suciu et al; and U.S. Pat. No. 4,415,460 to Suciu et al. U.S. Pat. No. 5,532,389 to Trent et al discloses removing chlorates from a chloride brine by contacting the chlorates with acid to convert the chlorates to chlorine. Additionally, it is disclosed that by-product organic compounds, such as propylene glycol present in a brine stream containing alkylene oxide are advantageously removed through any oxidation, extraction or absorption process.

U.S. Pat. No. 4,126,526 to Kwon et al discloses an integrated process for electrolytic production of chlorine and the production of an olefin oxide via the chlorohydrin wherein the chlorohydrin is contacted with an aqueous solution of sodium hydroxide and sodium chloride from the cathode compartment of an electrolytic cell, to produce the oxide and brine. The brine is contacted with gaseous chlorine to oxidize organic impurities to volatile organic fragments, which are stripped from the brine, prior to recycling the brine to the electrolytic cell.

In the processes of the two Suciu et al patents, U.S. Pat. Nos. 4,240,885 and 4,415,460; organic impurities in aqueous salt solutions; e.g., alkali or alkaline earth chloride solutions in particular, brines, are oxidized with chlorate ions to convert organics to carbon dioxide. However the processes employ harsh reaction conditions of high temperatures, which are above 130° C., requiring high pressure equipment, a low pH of less than 5, most preferably less than 1, and chlorate ions which tend to form chlorinated organic compounds.

Opportunities therefore remain to further improve the purification of aqueous brine solutions containing organic compounds so that the brine can be used for chlor-alkali electrolysis.

### SUMMARY OF THE INVENTION

The present invention provides methods for reducing high total organic carbon (TOC) contents of brine by-product streams having a high concentration of sodium chloride, such as a brine by-product stream from the production of epichlorohydrin from glycerin, without deleterious precipitation of the sodium chloride in separation equipment, and under relatively mild reaction conditions. The formation of undesirably corrosive or toxic chlorinated organic compounds during chemical treatment to destroy the organic compounds is avoided in the present invention. A recyclable brine stream having very low levels of TOC of less than about 10 ppm may be achieved without significant discharge of wastewater or consumption of fresh water.

The TOC content of a brine by-product stream having a high TOC content of from about 200 ppm to about 20,000 ppm, preferably from about 500 ppm to about 10,000 ppm is reduced in a plurality of stages under relatively mild temperature and reaction conditions to avoid formation of chlorate and chlorinated organic compounds while achieving a recyclable brine stream having a total organic carbon content of less than about 10 ppm. The low levels of TOC may be obtained even with brine recycle streams containing substantial amounts of difficult to remove organic compounds such as glycerin. The sodium chloride content of the brine by-product stream may be from about 15% by weight to about 23% by weight, based upon the weight of the brine by-product stream. The methods of the present invention may be employed for substantially reducing the TOC content of a brine by-product stream produced in the production of epichlorohydrin from glycerin, which may have a glycerin content of at least about 50% by weight, generally at least about 70% by weight by weight, based upon the weight of the total organic carbon content.

In embodiments of the invention, in a first stage treatment, a brine by-product stream having a high total organic carbon content, may be subjected to chlorinolysis at a temperature of less than about 125° C., but generally higher than about 60° C., for example from about 85° C. to about 110° C., preferably from about 90° C. to about 100° C., to obtain a chlorinolysis product stream having a TOC content of less than about 100 ppm. The chlorinolysis product stream may be treated in a second stage treatment with activated carbon to obtain a recyclable brine stream with a TOC content of less than about 10 ppm.

The chlorinolysis of the TOC of the brine by-product stream may be achieved by treatment of the brine by-product stream with sodium hypochlorite or bleach directly, or by treatment of the brine by-product stream with chlorine gas, Cl₂, and sodium hydroxide which form sodium hypochlorite in situ for the chlorinolysis.

For the chlorinolysis, the molar ratio of the sodium hypochlorite to the total organic carbon in the brine by-product stream may be from about 0.5 to 5 times the stoichiometric ratio of sodium hypochlorite to total organic carbon content of the brine by-product stream. In preferred embodiments, the chlorinolysis may be conducted at a molar ratio of sodium hypochlorite to the total organic carbon content in the brine by-product stream which is in excess of the stoichiometric ratio of sodium hypochlorite to total organic carbon content of the brine by-product stream. A preferred stoichiometric excess may be a molar ratio of sodium hypochlorite to the total organic carbon content in the brine by-product stream of from about 1.1 to about 2 times the stoichiometric ratio of sodium hypochlorite to total organic carbon content of the brine by-product stream.

The chlorinolysis may be conducted at a pH of about 3.5 to about 11.8 with or without the addition of a pH controlling or pH adjusting agent. Exemplary of pH controlling agents which may be employed are HCl and NaOH or other inorganic acids and bases. Atmospheric pressure or slightly elevated pressure sufficient to prevent boiling may be employed for the chlorinolysis. A residence time or reaction time for the chlorinolysis may be at least about 10 minutes, for example from about 30 minutes to about 60 minutes.

In preferred embodiments of the invention, the pH of the chlorinolysis product stream may be adjusted to a pH of about 2 to about 3 to protonate organic acids in the chlorinolysis product stream for the treatment with the activated carbon, and the activated carbon is acidified activated carbon obtained by washing activated carbon with hydrochloric acid.

In other embodiments of the invention, a brine by-product stream a brine recycle stream, or a chlorinolysis product stream, may be subjected to: (1) a Fenton oxidation with hydrogen peroxide and iron (II) catalyst in two stages, or (2) an activated carbon treatment followed by a Fenton oxidation with hydrogen and iron (II) catalyst to obtain a recyclable brine stream with a TOC content of less than about 10 ppm.

Other features and advantages of the present invention will be set forth in the description of invention that follows, and will be apparent, in part, from the description or may be learned by practice of the invention. The invention will be realized and attained by the compositions, products, and methods particularly pointed out in the written description and claims hereof.

### BRIEF DESCRIPTION OF THE DRAWINGS

The present invention is further described in the detailed description which follows, in reference to the figures of drawings by way of non-limiting example of exemplary embodiments of the present invention, wherein:

FIG. 1 schematically shows a process for reducing the total organic carbon content of a brine by-product stream according to the present invention.

FIG. 2 is a graph showing proof of concept destruction of glycerin in various brine streams by chlorinolysis with sodium hypochlorite at various conditions according to the present invention.

FIG. 3A shows destruction of glycerin in a brine stream as monitored by Nuclear Magnetic Resonance (NMR) by chlorinolysis at an acidic pH, at time equal to zero minutes.

FIG. 3B shows destruction of glycerin in a brine stream as monitored by NMR by chlorinolysis at an acidic pH, at time equal to 20 minutes.

FIG. 4A shows destruction of glycerin in a brine stream as monitored by NMR by chlorinolysis at a basic pH, at time equal to zero minutes.

FIG. 4B shows destruction of glycerin in a brine stream as monitored by NMR by chlorinolysis at a basic pH, at time equal to sixty minutes.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

A plurality of stages is employed in the present invention to reduce the total organic carbon (TOC) content of a brine by-product stream to produce a recyclable brine stream having a total organic carbon content of less than about 10 ppm. Employing a plurality of stages rather than a single stage permits the use of relatively mild conditions to reach a very low TOC content while avoiding any significant production of undesirable chlorinated organic compounds or chlorates, and any significant precipitation of sodium chloride. The first stage generally reduces a substantial portion, for example at least about 60% by weight, preferably at least about 75% by weight, most preferably at least about 85% by weight of the TOC content of the brine by-product stream, with the remainder of the reduction being performed in one or more additional stages. The brine recycle streams which may be treated in accordance with the present invention may have a sodium chloride content of from about 15% by weight to about 23% by weight, based upon the weight of the brine by-product stream, a high TOC content of from about 200 ppm to about 20,000 ppm, preferably from about 500 ppm to about 10,000 ppm, most preferably from about 500 ppm to about 5,000 ppm, and a pH of from about 7 to about 14, preferably 8 to 13, most preferably 10 to 12.5. In preferred embodiments of the invention, the TOC of the brine recycle stream is reduced to less than about 100 ppm in the first stage, and then is reduced to less than about 10 ppm in the second or final stage.

The purified or recyclable brine stream containing a TOC of less than about 10 ppm and a sodium chloride content of about 15% by weight to about 23% by weight, based upon the weight of the recyclable brine stream obtained in the present invention may be used in a variety of on-site, local, or off-site processes. Exemplary of such processes are chloro-alkali processes, electrochemical processes, such as for the production of chlorine and caustic, production of epoxides, a chlorine alkali membrane process, and the like.

The brine by-product stream treated in accordance with the present invention may be any stream where water, sodium chloride, and TOC is present in a waste, recycle, or by-product stream. Exemplary of brine streams to which the TOC reduction process of the present invention may be applied are a recycle or by-product brine stream obtained in the production of epichlorohydrin from glycerin, a liquid epoxy resin (LER) or other epoxy resin brine/salt recycle stream, other chlorohydrin brine recycle streams, and an isocyanate brine recycle stream. The low levels of TOC may be obtained even with brine recycle streams containing substantial amounts of difficult to remove organic compounds such as glycerin.

For example, the processes of the present invention are eminently applicable to the treatment of a brine by-product stream produced in the production of epichlorohydrin from glycerin. A brine by-product stream from a glycerin to epichlorohydrin (GTE) process which may be treated in accordance with the present invention may have an average TOC content of at least about 200 ppm, generally at least about 500 ppm, for example from about 1000 ppm to about 2500 ppm, preferably up to about 1500 ppm. The GTE brine by-product stream subjected to the TOC reduction of the present invention may have a glycerin content of at least about 50% by weight, generally at least about 70% by weight by weight, based upon the weight of the total organic carbon content, and a sodium chloride content of from about 15% by weight to about 23% by weight, based upon the weight of the brine by-product stream. The other organic compounds contributing to TOC in the GTE by-product stream include glycidol, acetol, bis-ethers, dichloro propyl glycidyl ethers, DCH, MCH, epichlorohydrin, diglycerol, triglycerol, other oligomeric glycerols, chlorohydrins of oligomeric glycerols, acetic acid, formic acid, lactic acid, glycolic acid, and other aliphatic acids.

Amounts of certain organic compounds are presented below in Table 1 based on the total weight of the respective organic compound in the aqueous brine solution.

TABLE 1
Preferred Concentrations of Organic
Compounds in Parts-per-Million (ppm)

| Organic Compound | Preferred Minima | | | Preferred Maxima | | |
|---|---|---|---|---|---|---|
| Glycerine | 0 | 500 | 2,000 | 5,000 | 10,000 | 50,000 |
| Glycidol | 0 | 50 | 200 | 500 | 1,000 | 5,000 |
| Hydroxy-2- | 0 | 10 | 40 | 100 | 300 | 1,000 |
| propanone | | | | | | |
| Bis-Ethers | 0 | 0.01 | 0.1 | 1 | 5 | 10 |
| Dichloropropyl | 0 | 0.01 | 0.1 | 11 | 22 | 33 |
| glycidyl ethers | | | | | | |
| Epichlorohydrin | 0 | 0.01 | 0.1 | 1 | 10 | 100 |
| Bisphenol A | 0 | 100 | 500 | 5,000 | 10,000 | 50,000 |
| Bisphenol F | 0 | 100 | 500 | 5,000 | 10,000 | 50,000 |
| Diglycidyl ether of | 0 | 100 | 500 | 5,000 | 10,000 | 50,000 |
| bisphenol A | | | | | | |
| Aniline | 0 | 100 | 500 | 5,000 | 10,000 | 50,000 |
| Methylene | 0 | 100 | 500 | 5,000 | 10,000 | 50,000 |
| dianiline | | | | | | |
| Phenol | 0 | 100 | 500 | 5,000 | 10,000 | 50,000 |
| Formate | 0 | 1 | 5 | 75 | 400 | 1000 |
| Acetate | 0 | 1 | 5 | 75 | 400 | 1000 |
| Lactate | 0 | 1 | 5 | 75 | 400 | 1000 |
| Glycolate | 0 | 1 | 5 | 75 | 400 | 1000 |

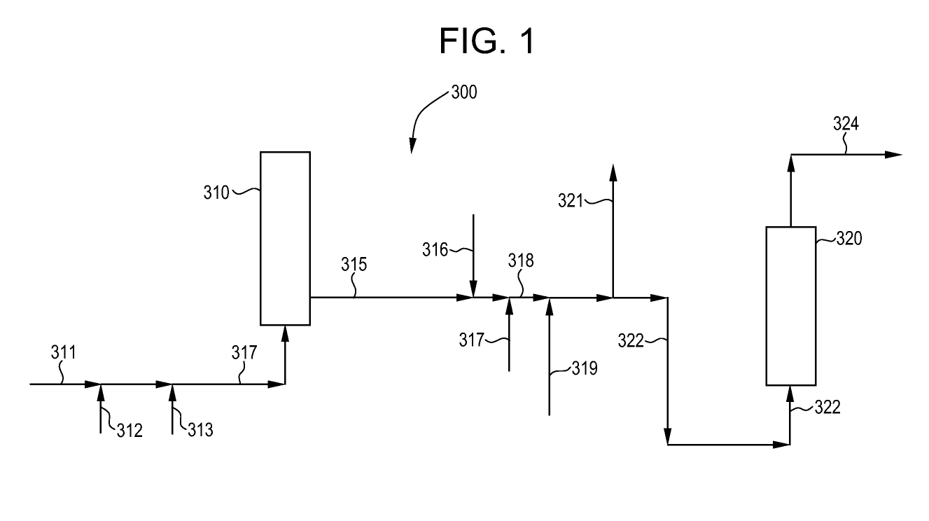

A first stage treatment of a brine by-pass stream to reduce the TOC content in accordance with embodiments of the present invention may be chlorinolysis to obtain a chlorinolysis product stream, which in turn may be treated in a second stage treatment with activated carbon as shown in FIG. 1. The chlorinolysis may be a reaction with chlorine gas and sodium hydroxide, or a reaction with sodium hypochlorite to decompose, destroy, or remove organic carbon compounds. The reaction with chlorine gas and sodium hydroxide may produce sodium hypochlorite in situ, or sodium hypochlorite or bleach may be admixed with or added directly to the brine by-product stream for chlorinolysis. Subjecting the brine by-pass stream to chlorinolysis with chlorine gas and sodium hydroxide is preferred with sodium hypochlorite being formed in-situ in accordance with equation (I):

2NaOH+Cl₂=NaOCl+NaCl+H₂O (I)

The chlorinolysis with direct addition of sodium hypochlorite or with in situ formation of sodium hypochlorite by the addition of chlorine gas and sodium hydroxide may be conducted at a temperature of less than about 125° C., but generally higher than about 60° C., for example from about 85° C. to about 110° C., preferably from about 90° C. to about 100° C., to obtain a chlorinolysis product stream having a TOC content of less than about 100 ppm.

For the chlorinolysis, the molar ratio of the sodium hypochlorite added directly or produced in situ to the total organic carbon in the brine by-product stream may be from about 0.5 to 5 times the stoichiometric ratio of sodium hypochlorite to total organic carbon content of the brine by-product stream. For example, for glycerin as a major component of the TOC in a GTE brine by-pass stream, the stoichiometric ratio of sodium hypochlorite to the glycerin component of the TOC is 7:1 as shown in equation (II):

C₃H₈O₃+7NaOCl=3CO₂+7NaCl+4H₂O (II)

In preferred embodiments, the chlorinolysis may be conducted at a molar ratio of sodium hypochlorite to the total organic carbon content in the brine by-product stream which is in excess of the stoichiometric ratio of sodium hypochlorite to total organic carbon content of the brine by-product stream. A preferred stoichiometric excess may be a molar ratio of sodium hypochlorite to the total organic carbon content in the brine by-product stream of from about 1.1 to about 2 times the stoichiometric ratio of sodium hypochlorite to total organic carbon content of the brine by-product stream.

In embodiments where the chlorinolysis is conducted by treatment of a brine by-product stream with chlorine gas and sodium hydroxide, the amount of chlorine gas and the amount of sodium hydroxide which is employed in the chlorinolysis is sufficient to produce sodium hypochlorite according to equation (I) in a sufficient quantity so that the molar ratio of sodium hypochlorite produced to the total organic carbon content in the brine by-product stream is from about 0.5 to 5 times, preferably greater than one time, most preferably from about 1.1 to about 2 times the stoichiometric ratio of sodium hypochlorite to total organic carbon content of the brine by-product stream.

The chlorinolysis may be conducted at a pH of about 3.5 to about 11.8, with a preferred acidic pH being from about 3.5 to about 5.5, and a preferred alkaline or basic pH being from about 8.5 to about 11.8. The use of a lower acidic pH, such as a pH of less than 3, such as 1 or 2 may lower the TOC to less than about 10. However, such harsh, low pH's during chlorinolysis tends to result in the deleterious production of chlorinated carbon compounds. The chlorinolysis may be conducted with or without the addition of a pH controlling or pH adjusting agent such as HCl and NaOH or other inorganic acids and bases. In embodiments where a pH adjusting agent is not added for the chlorinolysis, the reaction may begin at an alkaline pH of the brine by-product stream and may be permitted to drop as the reaction proceeds within the pH range of about 3.5 to about 11.8.

The chlorinolysis may be conducted at atmospheric pressure or slightly elevated pressure sufficient to prevent boiling and evaporation of water which may cause precipitation of the sodium chloride. As the reaction temperature is increased above the boiling point of the brine by-product stream, higher pressures are employed to prevent substantial boiling and evaporation of the water present in the stream. A residence time or reaction time for the chlorinolysis may be at least about 10 minutes, for example from about 30 minutes to about 60 minutes.

The chlorinolysis product stream from the chlorinolysis reactor may have a TOC content of less than about 100 ppm and may be treated in a second stage treatment with activated carbon to obtain a recyclable brine stream with a TOC content of less than about 10 ppm. The treatment with the activated carbon may be conducted at a temperature of less than about 100° C., preferably less than about 60° C., most preferably at about room temperature. In preferred embodiments of the invention, the pH of the chlorinolysis product stream may be adjusted using an acid and/or a base such as sodium hydroxide and/or hydrochloric acid for treatment in the second or subsequent stages. For example, it is preferred to adjust the pH of the chlorinolysis product stream to a pH of about 2 to about 3 to protonate organic acids in the chlorinolysis product stream for the treatment with the activated carbon. The activated carbon employed is preferably an acidified activated carbon obtained by washing activated carbon with hydrochloric acid.

In embodiments of the invention, the chlorinolysis product stream may be treated with hydrogen peroxide prior to treatment in the second stage with the activated carbon. The treatment with the hydrogen peroxide may be employed to eliminate or substantially eliminate any excess bleach or sodium hypochlorite present in the chlorinolysis product stream.

As schematically shown in FIG. 1, a chlorinolysis process, generally indicated by numeral 300, is shown comprising a primary chlorinolysis reactor 310 and a treatment vessel such as an activated carbon bed or column 330. As shown in FIG. 1, a brine by-product stream 311, for example from the production epichlorohydrin from glycerin (“GTE Brine” stream 311), having a TOC of about 1470 ppm and a pH of about 8 to about 9 may be admixed with a stream of chlorine gas 312 and a stream of sodium hydroxide 313 to obtain a chlorinolysis reaction mixture 314 having a pH of about 3.5 to about 9. The reaction mixture 314 is fed to the primary chlorinolysis reactor 310.

The outlet stream 315 from the chlorinolysis reactor 310, or the chlorinolysis product stream 315, may have a TOC of less than about 100 ppm. The carbon dioxide, sodium chloride and water reaction products resulting from the destruction of the TOC may be present in the chlorinolysis product stream 315, with the carbon dioxide being removable as a gas and/or being capable of forming a weak carbonic acid. The chlorinolysis product stream 315 may be admixed with a stream of sodium hydroxide 316 and/or a stream of hydrochloric acid 317 forming a pH adjusted product stream 318. The stream of sodium hydroxide 316 and/or a stream of hydrochloric acid 317 is used to adjust or maintain a pH of about 2 for the second stage treatment of the chlorinolysis product stream with acidified activated carbon.

In addition, prior to treatment in the activated carbon column 330, the chlorinolysis pH adjusted product stream 318 may alternatively be treated with a minimal amount of hydrogen peroxide via stream 319 to form stream 320. The hydrogen peroxide stream 319 may be used to remove any excess sodium hypochlorite in the chlorinolysis product stream 318. Also, any volatile compounds may be removed from stream 320 for sparging via a sparging line 321 forming stream 322. For the second stage treatment, the pH adjusted product stream 322 is preferably fed into an activated carbon bed or column 330 containing the acidified activated carbon. A purified or recyclable brine product stream 331 exits from the activated carbon column 330. The purified or recyclable brine product stream 331 from the activated carbon column 330 may have a TOC of less than about 10 ppm.

In other embodiments of the invention, where a plurality of stages are employed for reducing the TOC of a brine by-product stream, a brine recycle stream, or a chlorinolysis product stream, the stream may be subjected to an activated carbon treatment followed by a Fenton oxidation with hydrogen and iron (II) catalyst to obtain a recyclable brine stream with a TOC content of less than about 10 ppm.

For example, the hydrolyser bottoms stream from a glycerin to epichlorohydrin process (GTE) may contain common salt (sodium chloride) in a concentration of over 16% by weight. The stream is worth recycling to a chlorine/alkali membrane process (Membrane C/A). For this purpose, it must be freed from organic contamination, essentially from glycerin which is present in a concentration of usually over 0.10% by weight (1000 ppm) and from other organic contaminants which may be present in low to trace concentrations.

In accordance with an embodiment of the present invention, purification of the brine contaminated with organic compounds may be achieved by carbon adsorption of organic components and subsequent post-treatment (polishing) for mitigation of remaining organics by treatment with a Fenton Oxidation process to an appropriate level such that the purified brine can be fed to the Membrane C/A cells. The adsorption may be performed in several drums equipped with fixed carbon beds to allow for adsorption and regeneration at the same time. The feed may be adjusted to a pH of 7. The regeneration may be performed with hot water, and if a total regeneration is required from time to time with an organic solvent. The regenerate may be sent to a biological treatment facility. The adsorption may be followed by a Fenton Oxidation unit. The pH of the feed may be adjusted to 3 before hydrogen peroxide and iron-II catalyst are added to the feed before the mixture enters a reactor which is operated at elevated temperature and pressure to ensure the chemical oxidation of remaining traces of organic compounds from the adsorption. After leaving the reactor, the catalyst may be removed via precipitation due to change of pH. The precipitate may be removed after some conditioning in a filter unit.

The process where adsorption is combined with a one-step chemical process for mitigation of traces of organics does not require strong oxidants to remove the organics and is therefore economical. Also, both process steps are easy to control and enable a high degree of automation and low level of supervision. The adsorption may be setup as a temperature swing adsorption which allows easy regeneration of the resin. For the Fenton stage, the oxidation with peroxide does not impure the brine because it decomposes to water and oxygen and the iron catalyst can be removed via easy precipitation. The combination of a specific way of treatment (adsorption) with an unspecific (Fenton Oxidation) allows for adaptation for swings in the feed, and adjustment to a pH of 3 for the Fenton oxidation supports the desired reactions.

In other embodiments of the invention, where a plurality of stages are employed for reducing the TOC of a brine by-product stream, a brine recycle stream, or a chlorinolysis product stream, the stream may be subjected to a Fenton oxidation with hydrogen peroxide and iron(II) catalyst in two stages.

For example, in a double or two stage Fenton oxidation, purification of the brine contaminated with organic compounds, may be achieved by using a Fenton Oxidation process to an appropriate level such that the purified brine can be fed to chlorine/alkali membrane process (Membrane C/A) cells. The hydrolyser bottoms stream from a glycerin to epichlorohydrin process (GTE) containing common salt (sodium chloride) in a concentration of over 16% by weight and organic contamination, essentially from glycerin which may be present in a concentration of usually over 0.10% by weight (1000 ppm) may be subjected to Fenton oxidation in two separate stages. In the double Fenton oxidation process, the pH of the brine by-product feed is adjusted to 3 before hydrogen peroxide and iron-II catalyst are added to the feed before the mixture enters the first reactor. The first reactor performs the biggest part of destruction of the TOC content of the brine by-product feed. Before the outlet stream of the first reactor enters the second reactor additional catalyst and peroxide are added. In the second reactor the remaining TOC is destroyed down to a level of less than 10 ppm. Both reactors may be operated at elevated temperatures and pressures to ensure the chemical oxidation of organic compounds from the GTE plant. After leaving the reactor the catalyst may be removed via precipitation due to change of pH. The precipitate may be removed after some conditioning in a filter unit.

The two stage Fenton oxidation process of the present invention does not impure the brine by using strong oxidants because the iron from the catalyst may be easily removed in a filter unit and the peroxide decomposes to water and oxygen. Adjustment to a pH of 3 for the Fenton oxidation supports the desired reactions, the Fenton oxidation process steps are easy to control, enable a high degree of automation and enable a low level of supervision. The Fenton oxidation process employs low cost reactants and can be applied to a wide range of operating parameters.

All references cited herein are specifically incorporated by reference herein.

The following examples, wherein all parts, percentages, and ratios are by weight, all temperatures are in ° C., and all pressures are atmospheric unless indicated to the contrary, illustrate the present invention:

### Example 1

Small scale proof of concept laboratory experiments for the destruction of organic compounds in a brine by-product stream from the production of epichlorohydrin from glycerin (GTE brine) were conducted under low or acidic pH of about 3.5 to about 5.5 and under high or alkaline pH of about 11.8 to about 8.5 chlorinolysis conditions. The demonstration of proof of concept and kinetics studies experiments were conducted in an NMR tube or reacti-vials using about 1 to about 2 gram samples. The samples tested were either pure glycerin dissolved in water or a GTE brine having a total organic carbon (TOC) content of about 1470 ppm and a starting pH of about 11.8. The sodium chloride content of the GTE brine was about 23% by weight. The synthetic glycerin samples or the GTE brine samples were heated with excess bleach, which is an about 6.5% by weight aqueous solution of sodium hypochlorite, at temperatures ranging from about 90° C. to about 100° C., and glycerin destruction was monitored by NMR. The samples tested, chlorinolysis reaction temperature, and stoichiometric excess of sodium hypochlorite, assuming the stoichiometry of equation (II) were:

1. pure glycerin at a concentration of about 2,500 ppm, treated at about 90° C. with about a 4-fold sodium hypochlorite excess,

2. pure glycerin at a concentration of about 5,000 ppm, treated at about 110° C. with about a 2-fold sodium hypochlorite excess,

3. GTE brine with a starting TOC content of about 1470 ppm, treated at about 90° C. with about a 3.3-fold sodium hypochlorite excess,

4. GTE brine with a starting TOC content of about 1470 ppm, treated at about 110° C. with about a 3.3-fold sodium hypochlorite excess, and

5. GTE brine with a starting TOC content of about 1470 ppm, treated at about 110° C. with about an 8.2-fold sodium hypochlorite excess.

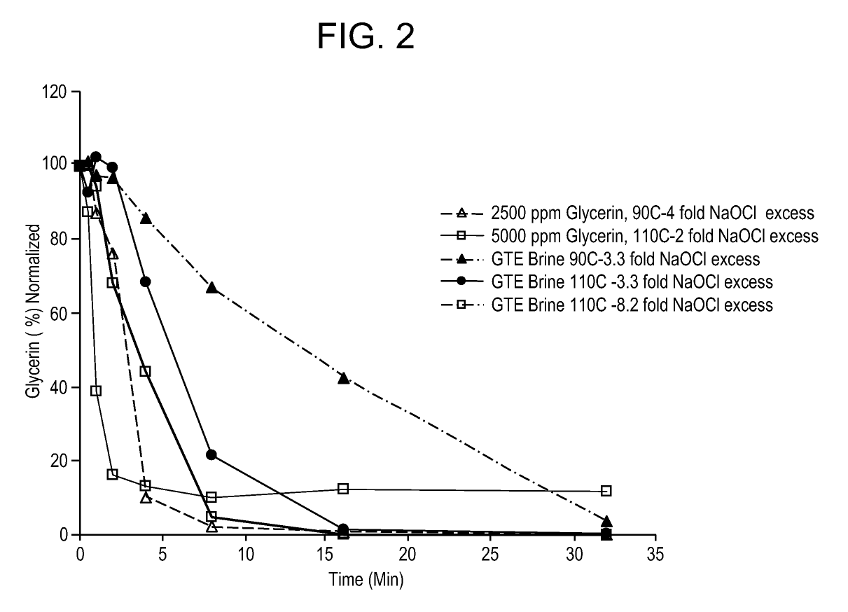

As shown FIG. 2, the glycerin destruction data indicates that a majority of glycerin, which is a major component contributing to the TOC in GTE brine was destroyed under a variety of chlorinolysis conditions.

### Example 2

After demonstration of the proof of concept in Example 1, experiments were conducted on a larger scale and in addition to monitoring of glycerin destruction by NMR, the total organic carbon (TOC) was also monitored in a chlorinolysis reaction under acidic or low pH conditions. The brine by-product stream subjected to the chlorinolysis was a brine by-product stream from the production of epichlorohydrin from glycerin (GTE brine) having a TOC content of about 1470 ppm, a sodium chloride content of about 23% by weight, based upon the weight of the GTE brine, and a pH of about 9. A 133 g sample of the GTE brine was admixed with about 66 g of commercial bleach in a flask. The commercial bleach had a sodium hypochlorite content of about 6.5% by weight, with the balance being water.

Upon dilution of the GTE brine with the bleach, the calculated TOC content of the mixture of GTE brine and bleach is about 982 ppm. On a calculated basis, assuming all of the TOC is glycerin, the amount of glycerin in the GTE brine sample is about 5.06 mmoles. The amount of sodium hypochlorite supplied by the bleach is about 57.5 mmole of sodium hypochlorite. The molar ratio of sodium hypochlorite to glycerin is about 11.36 (57.5 mmole/5.06 mmole=11.36). Thus, the excess sodium hypochlorite over stoichiometry, or the molar ratio of the sodium hypochlorite to the total organic carbon (calculated as all glycerin) in the brine by-product stream may be about 1.62 times the stoichiometric ratio (7:1) of sodium hypochlorite to total organic carbon content (calculated as all glycerin according to equation (II)) of the brine by-product stream (11.36/7=1.62).

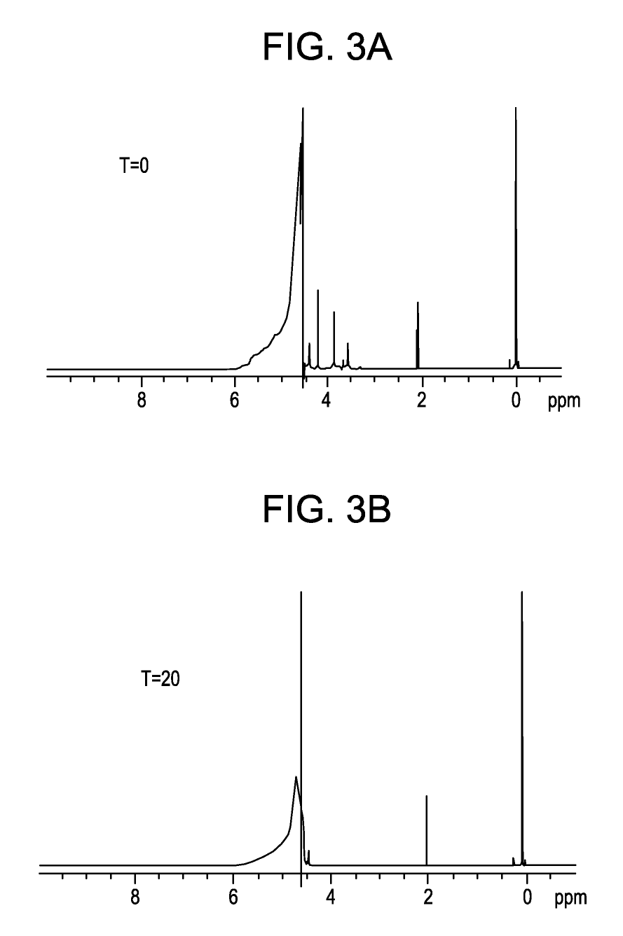

The mixture of GTE brine and bleach is admixed with hydrochloric acid (HCl) in the flask to adjust the pH of the reaction mixture to about 3.5 to about 5.5. The reaction mixture is mixed and heated in the flask at a temperature of about 100° C. for 20 minutes at atmospheric pressure. During the reaction, a reaction mixture pH of about 3.5 to about 5 is maintained by adding hydrochloric acid (HCl) or sodium hydroxide (NaOH) for pH adjustment as needed. Glycerin destruction achieved with the chlorinolysis is monitored using NMR. The reaction mixture is cooled down to about room temperature, and the TOC is measured to be about 55 ppm. The NMR spectrum at the start of the chlorinolysis (Time=0) is shown in FIG. 3A, and after the chlorinolysis (Time=60 minutes) is shown in FIG. 3B. As shown in FIGS. 3A and 3B, the NMR spectrum indicates that the chlorinolysis results in very substantial destruction of glycerin and no peaks for any new organic compounds.

The cooled reaction mixture is admixed with hydrochloric acid to adjust the pH of the chlorinolysis reaction product to about 2 for treatment with acidified activated carbon. About 15 g of acidified activated carbon is placed in a 50 ml burette, and conditioned with hydrochloric acid having a pH of about 2 to remove any impurities. The chlorinolysis reaction product is then added to the burette and the effluent is analyzed for TOC using a TOC analyzer. The acidified activated carbon reduces the TOC of the chlorinolysis reaction product from about 55 ppm down to less than 10 ppm as measured by the TOC analyzer.

### Example 3

After demonstration of the proof of concept in Example 1, experiments were conducted on a larger scale and in addition to monitoring of glycerin destruction by NMR, the total organic carbon (TOC) was also monitored in a chlorinolysis reaction under basic or high pH conditions. The brine by-product stream subjected to the chlorinolysis was a brine by-product stream from the production of epichlorohydrin from glycerin (GTE brine) having a TOC content of about 1470 ppm, a sodium chloride content of about 23% by weight, based upon the weight of the GTE brine, and a pH of about 11.8. A 133 g sample of the GTE brine was admixed with about 56 g of commercial bleach in a flask. The commercial bleach had a sodium hypochlorite content of about 6.5% by weight, with the balance being water.

Upon dilution of the GTE brine with the bleach, the calculated TOC content of the mixture of GTE brine and bleach is about 1040 ppm. On a calculated basis, assuming all of the TOC is glycerin, the amount of glycerin in the GTE brine sample is about 5.139 mmoles. The amount of sodium hypochlorite supplied by the bleach is about 48.772 mmole of sodium hypochlorite. The molar ratio of sodium hypochlorite to glycerin is about 9.49 (48.772 mmole/5.139 mmole=9.49). Thus, the excess sodium hypochlorite over stoichiometry, or the molar ratio of the sodium hypochlorite to the total organic carbon (calculated as all glycerin) in the brine by-product stream may be about 1.35 times the stoichiometric ratio (7:1) of sodium hypochlorite to total organic carbon content (calculated as all glycerin according to equation (II)) of the brine by-product stream (9.49/7=1.35).

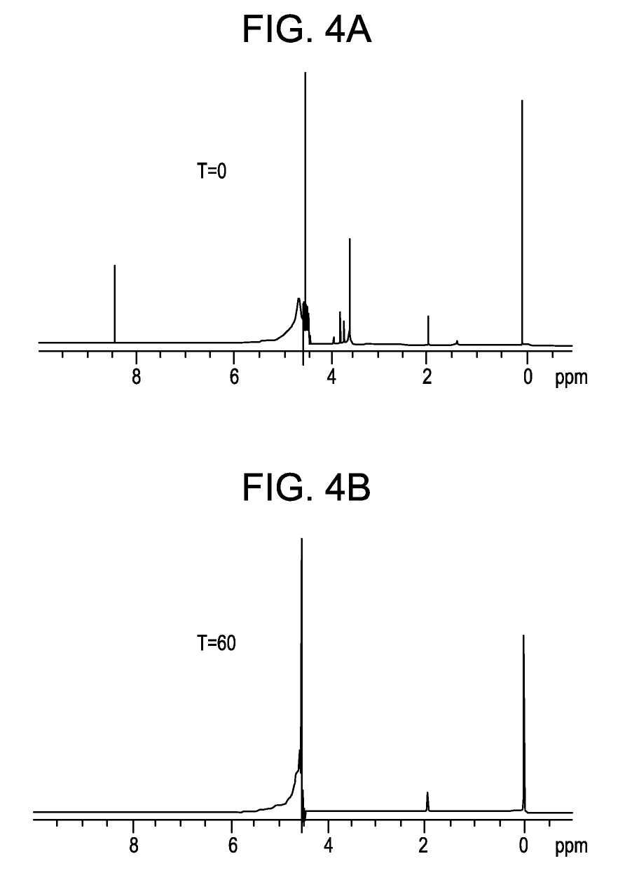

The mixture of GTE brine and bleach is not admixed with any pH control agent such as hydrochloric acid (HCl) or sodium hydroxide (NaOH) for adjusting or maintaining the pH of the reaction mixture. The initial pH is permitted to fall as the reaction proceeds. The reaction mixture is mixed and heated in the flask at a temperature of about 100° C. for 20 minutes at atmospheric pressure. During the reaction, the reaction mixture pH drops to about 8.8 to about 8.5. Glycerin destruction achieved with the chlorinolysis is monitored using NMR. The reaction mixture is cooled down to about room temperature, and the TOC is measured to be about 82 ppm. The NMR spectrum at the start of the chlorinolysis (Time=0) is shown in FIG. 4A, and after the chlorinolysis (Time=60 minutes) is shown in FIG. 4B. As shown in FIGS. 4A and 4B, the NMR spectrum indicates that the chlorinolysis results in very substantial destruction of glycerin and no peaks for any new organic compounds.

The cooled reaction mixture is admixed with hydrochloric acid to adjust the pH of the chlorinolysis reaction product to about 2 for treatment with acidified activated carbon. About 15 g of acidified activated carbon is placed in a 50 ml burette, and conditioned with hydrochloric acid having a pH of about 2 to remove any impurities. The chlorinolysis reaction product is then added to the burette and the effluent is analyzed for TOC using a TOC analyzer. The acidified activated carbon reduces the TOC of the chlorinolysis reaction product from about 82 ppm down to less than 10 ppm as measured by the TOC analyzer.

Although the present invention has been described in considerable detail with regard to certain versions thereof, other versions are possible, and alterations, permutations, and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the processes of the present invention can be carried out with a wide and equivalent range of conditions, formulations, and other parameters without departing from the scope of the invention or any embodiments thereof.

What is claimed is:

1. A process for reducing the total organic carbon content of a brine by-product stream comprising:
(a) subjecting a brine by-product stream having a high total organic carbon content to chlorinolysis at a temperature of less than about 125° C. to obtain a chlorinolysis product stream, and
(b) treating the chlorinolysis product stream with activated carbon to obtain a recyclable brine stream.

2. A process for reducing the total organic carbon content of a brine by-product stream as claimed in claim 1 wherein said chlorinolysis comprises treatment of the brine by-product stream with sodium hypochlorite.

3. A process for reducing the total organic carbon content of a brine by-product stream as claimed in any of the preceding claims wherein the molar ratio of the sodium hypochlorite to the total organic carbon in the brine by-product stream is a stoichiometric excess of the sodium hypochlorite.

4. A process for reducing the total organic carbon content of a brine by-product stream as claimed in any of the preceding claims wherein said chlorinolysis comprises treatment of the brine by-product stream with chlorine gas and sodium hydroxide to obtain sodium hypochlorite for reaction with the total organic carbon content of the brine by-product stream.

5. A process for reducing the total organic carbon content of a brine by-product stream as claimed in any of the preceding claims wherein the molar ratio of the sodium hypochlorite to the total organic carbon in the brine by-product stream is a stoichiometric excess of the sodium hypochlorite.

6. A process for reducing the total organic carbon content of a brine by-product stream as claimed in any of the preceding claims wherein the chlorinolysis is conducted at a pH of about 3.5 to about 11.8.

7. A process for reducing the total organic carbon content of a brine by-product stream as claimed in any of the preceding claims wherein the molar ratio of the sodium hypochlorite to the total organic carbon in the brine by-product stream is from about 0.5 to 5 times the stoichiometric ratio of sodium hypochlorite to total organic carbon content of the brine by-product stream.

8. A process for reducing the total organic carbon content of a brine by-product stream as claimed in any of the preceding claims wherein the chlorinolysis is conducted at a temperature of from about 85° C. to about 110° C. to obtain said chlorinolysis product stream.

9. A process for reducing the total organic carbon content of a brine by-product stream as claimed in any of the preceding claims wherein the total organic carbon content of the brine by-product stream comprises glycerin in an amount of at least about 50% by weight, based upon the weight of the total organic carbon content.

10. A process for reducing the total organic carbon content of a brine by-product stream as claimed in any of the preceding claims wherein the brine by-product stream is produced in the production of epichlorohydrin from glycerin.

11. A process for reducing the total organic carbon content of a brine by-product stream as claimed in any of the preceding claims wherein the total organic carbon content of the brine by-product stream subjected to said chlorinolysis is at least about 500 ppm by weight, the chlorinolysis reduces the total organic carbon content of the brine by-product stream to less than about 100 ppm by weight, and the treatment of the chlorinolysis product stream with the activated carbon further reduces the total organic carbon content of the chlorinolysis product stream to less than about 10 ppm by weight to obtain said recyclable brine stream.

12. A process for reducing the total organic carbon content of a brine by-product stream as claimed in any of the preceding claims wherein the pH of said chlorinolysis product stream is adjusted to a pH of about 2 to about 3 for said treatment with the activated carbon.

13. A process for reducing the total organic carbon content of a brine by-product stream as claimed in any of the preceding claims wherein said recyclable brine stream is recycled to a chlor-alkali process.

14. A process for reducing the total organic carbon content of a brine by-product stream as claimed in any of the preceding claims wherein the chlorinolysis is conducted at about atmospheric pressure, a residence time of about 30 minutes to about 60 minutes, and a temperature of about 90° C. to about 100° C.

15. A process for reducing the total organic carbon content of a brine by-product stream as claimed in any of the preceding claims wherein the sodium chloride content of said brine by-product stream is from about 15% by weight to about 23% by weight, based upon the weight of the brine by-product stream.

16. A process for reducing the total organic carbon content of a brine by-product stream as claimed in any of the preceding claims wherein the pH of said chlorinolysis product stream is adjusted to a pH of about 2 to about 3 to protonate organic acids in the chlorinolysis product stream for said treatment with the activated carbon, and said activated carbon is acidified activated carbon obtained by washing activated carbon with hydrochloric acid.

17. The process according to claims 1 to 16, wherein the brine by-product stream comes from a chemical process for reacting polyphenol compound with epichlorohydrin to make epoxy resins and the different chemical process is a chlor-alkali process.

18. The process according to claim 17, wherein the brine by-product stream comes from a chemical process for making liquid epoxy resin or solid epoxy resin from bisphenol-A and epichlorohydrin.

19. The process according to claim 17, wherein the brine by-product stream comes from a chemical process for making liquid epoxy novolac resin from bisphenol-F, or bisphenol-F oligomers, and epichlorohydrin.

20. The process according to claims 1 to 16, wherein the brine by-product stream comes from a chemical process for making methylene dianiline, or poly-methylene dianiline oligomers from phenol and formaldehyde in the presence of hydrochloric acid.

21. A process for reducing the total organic carbon content of a brine by-product stream comprising:
(a) subjecting a brine by-product stream produced in the production of epichlorohydrin from glycerin to chlorinolysis by admixing the brine by-product stream with chlorine gas and sodium hydroxide at a pH of about 3.5 to about 11.8 and a temperature of less than about 125° C., said brine by-product stream having a total organic carbon content of at least about 500 ppm by weight and a sodium chloride content of about 15% by weight to about 23% by weight, based upon the weight of the brine by-product stream, wherein the chlorinolysis reduces the total organic carbon content of the brine by-product stream to less than about 100 ppm by weight, based upon the weight of the resulting chlorinolysis product stream;
(b) adjusting the pH of the chlorinolysis product stream to a pH of about 2 to about 3; and
(c) treating the chlorinolysis product stream with acidified activated carbon to obtain a recyclable brine stream, wherein treatment of the chlorinolysis product stream with the activated carbon further reduces the total organic carbon content of the chlorinolysis product stream to less than about 10 ppm by weight.

22. A process for reducing the total organic carbon content of a brine by-product stream as claimed in claim 21 wherein the amount of chlorine gas and the amount of sodium hydroxide employed in the chlorinolysis provides a molar ratio of sodium hypochlorite to the total organic carbon content in the brine by-product stream of from about 0.5 to 5 times the stoichiometric ratio of sodium hypochlorite to total organic carbon content of the brine by-product stream.

23. A process for reducing the total organic carbon content of a brine by-product stream as claimed in claim 21 or 22 wherein the chlorinolysis is conducted at a molar ratio of sodium hypochlorite to the total organic carbon content in the brine by-product stream which is in excess of the stoichiometric ratio of sodium hypochlorite to total organic carbon content of the brine by-product stream.

24. A process for reducing the total organic carbon content of a brine by-product stream as claimed in any of claims 21-23 wherein the chlorinolysis is conducted at about atmospheric pressure, a residence time of about 30 minutes to about 60 minutes, a temperature of about 90° C. to about 100° C., and a molar ratio of sodium hypochlorite to the total organic carbon content in the brine by-product stream of from about 1.1 to about 2.

25. A process for reducing organic contamination of brine in a chemical process comprising subjecting a brine stream of the chemical process to the purification process of claim 1; wherein the organic content of purified brine is sufficiently low to be recycled back to the same chemical process or a different chemical process.

26. The process according to claim 25, wherein the chemical process is a process for making epichlorohydrin and the different chemical process is a chlor-alkali process.

27. The process according to claim 25, wherein the chemical process is a process for reacting a polyphenol compound with epichlorohydrin to make epoxy resins and the different chemical process is a chlor-alkali process.

28. The process according to claim 27, wherein the chemical process is a process for making liquid epoxy resin or solid epoxy resin from bisphenol-A and epichlorohydrin.

29. The process according to claim 27, wherein the chemical process is a process for making liquid epoxy novolac resin from bisphenol-F, or bisphenol-F oligomers, and epichlorohydrin.

30. The process according to claim 25, wherein the chemical process is a process for making methylene dianiline, or poly-methylene dianiline oligomers from phenol and formaldehyde in the presence of a hydrochloric acid.

31. The process according to claim 26, wherein the chemical process is a process for making epichlorohydrin from glycerin.

32. The process according to any one of claims 25 to 31, wherein the weight-ratio of the amount of organic compound to the amount of sodium chloride present in the second purified brine solution obtained in the second redissolution step is less than about one-hundredth of the weight-ratio of the amount of organic compound to the amount of sodium chloride present in the aqueous brine solution provided in step (1).

33. The process according to any one of the preceding claims, wherein the one or more organic compounds comprise(s) (a) one or more multihydroxylated-aliphatic hydrocarbon compound(s), ester(s) thereof and/or monoepoxides thereof, and/or dimers, trimers and/or oligomers thereof, and/or halogenated and/or aminated derivatives thereof, (b) one or more organic acids having from 1 to 10 carbon atoms, ester(s) thereof, monoepoxide(s) thereof and/or salt(s) thereof, (c) one or more alkylene bisphenol compound(s) and/or epoxide(s), diols and/or chlorohydrins thereof, and/or (d) aniline, methylene dianiline, and/or phenol.

34. The process according to claim 33, wherein the one or more multihydroxylated-aliphatic hydrocarbon compound(s) comprise(s) glycerol.

35. The process according to claim 33, wherein the one or more organic acids comprise(s) formic acid, acetic acid, lactic acid and/or glycolic acid.

36. The process according to claim 33, wherein the one or more alkylene bisphenol compound(s) comprise(s) bisphenol A and/or bisphenol F.

37. The process according to any one of claims 33 to 36, wherein the aqueous brine solution provided in step (1) is produced by epoxidation of chlorohydrin(s) by reacting chlorohydrins with sodium hydroxide.

38. The process according to claim 37, wherein the chlorohydrin(s) is/are produced by contacting a liquid-phase reaction mixture comprising glycerol and/or ester(s) thereof and/or monochlorohydrin(s) and/or ester(s) thereof with at least one chlorinating feed stream comprising at least one chlorinating agent, optionally in the presence of water, one or more catalyst(s), and/or one or more heavy byproduct(s) in a reaction vessel under hydrochlorination conditions.

39. The process according to any one of claim 33, 36 or 37, wherein the aqueous brine solution provided in step (1) is produced by epoxidation of at least one alkylene bisphenol compound.

40. The process according to claim 33, wherein the aqueous brine solution provided in step (1) comprises aniline, methylene dianiline and/or phenol and is produced by sodium hydroxide neutralization of hydrogen chloride used to catalyze the reaction of aniline with formaldehyde to make methylene dianiline (MDA).

41. The process according to claim 40, wherein the aqueous brine solution produced by sodium hydroxide neutralization of hydrogen chloride is subjected to azeotropic distillation to remove at least 50 weight-percent of aniline and/or methylene dianiline present in the aqueous brine solution prior to providing the aqueous brine solution in step (1).

42. The process according to claim 41, wherein the aqueous brine solution provided in step (1) has not been subjected to a stripping operation to remove aniline and/or methylene dianiline prior to the first redissolution operation.

43. The process according to any one of the preceding claims, wherein the total organic carbon concentration (TOC) of the aqueous brine solution provided in step (1) is at least 200 ppm.

44. The process according to any one of the preceding claims, wherein less than 5 weight-percent of the inorganic salt of the aqueous brine solution provided in step (1) is salt having carbonate and/or sulfate anions.

45. The process according to any one of the preceding claims, wherein the purified brine solution obtained in step (2) has a total organic carbon concentration less than about 10 ppm.

46. The process according to any one of the preceding claims, wherein the purified brine is introduced into the anode side of an electrolytic cell as at least a portion of brine starting material for making (a) sodium hydroxide and (b) chlorine gas or hypochlorite via the chlor-alkali process.

47. The process according to any one of the preceding claims, wherein the process is a continuous process.
